(19) United States
(12) Patent Application Publication
(10) Pub. No.: US 2025/0282150 A1
(43) Pub. Date: Sep. 11, 2025

(54) IMAGE FORMING APPARATUS

(71) Applicant: KYOCERA Document Solutions Inc., Osaka (JP)

(72) Inventors: Tomoki Isono, Osaka (JP); Hiroshi Yokota, Osaka (JP); Yukio Shibata, Osaka (JP); Ryo Shiomi, Osaka (JP); Toshihiko Tanaka, Osaka (JP)

(21) Appl. No.: 19/061,215

(22) Filed: Feb. 24, 2025

(30) Foreign Application Priority Data
Mar. 5, 2024 (JP) 2024-032648

(51) Int. Cl. B41J 2/21

(52) U.S. Cl. CPC B41J 2/2139; B41J 2/2121; B41J 2/2146

(57) ABSTRACT

An image forming apparatus includes a line-head-type recording head, and a controller. The line-head-type recording head includes plural nozzles, and the recording head is configured to eject ink through the nozzles. The controller causes the recording head to eject ink and thereby performs printing of an image. Further, if a nozzle corresponding to a target pixel in the image performs ink ejection continuously in lines of a predetermined first line number, and one or both of two nozzles corresponding to both adjacent pixels to the target pixel does not/do not perform ink ejection continuously in lines of a predetermined second line number, then the controller causes the recording head to perform ink ejection of one or both of the two nozzles instead of ink ejection of the nozzle corresponding to the target pixel.

### CROSS-REFERENCE TO RELATED APPLICATIONS

This application relates to and claims priority rights from Japanese Patent Application No. 2024-032648, filed on Mar. 5, 2024, the entire disclosures of which are hereby incorporated by reference herein.

### BACKGROUND

### 1. Field of the Present Disclosure

The present disclosure relates to an image forming apparatus.

### 2. Description of the Related Art

An inkjet image forming apparatus performs multi-pass printing such that a ratio of dots continuously formed by one nozzle in once of scanning in a low density area becomes higher than that in a high density area, and thereby restrains image quality degradation due to ink viscosity increase without preliminary ink ejection.

However, a line-head-type image forming apparatus does not perform multi-pass printing, and therefore, hardly restrains image quality degradation due to ink viscosity increase without preliminary ink ejection in the aforementioned manner. It should be noted that if image quality degradation due to ink viscosity increase is restrained using preliminary ink ejection (ink flushing other than printing), mechanical configuration for preliminary ink ejection is required, and printing may be delayed due to preliminary ink ejection.

### SUMMARY

An image forming apparatus according to an aspect of the present disclosure includes a line-head-type recording head, and a controller. The line-head-type recording head includes plural nozzles, and the recording head is configured to eject ink through the nozzles. The controller causes the recording head to eject ink and thereby performs printing of an image. Further, if a nozzle corresponding to a target pixel in the image performs ink ejection continuously in lines of a predetermined first line number, and one or both of two nozzles corresponding to both adjacent pixels to the target pixel does not/do not perform ink ejection continuously in lines of a predetermined second line number, then the controller causes the recording head to perform ink ejection of one or both of the two nozzles instead of ink ejection of the nozzle corresponding to the target pixel.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of the image forming apparatus shown in FIG. 1;

FIG. 3 shows a block diagram that indicates an electronic configuration of the image forming apparatus 10 in the embodiment according to the present disclosure;

FIG. 4 shows a diagram that explains substitutional ejection in Embodiment 1;

FIG. 5 shows a flowchart that shows a behavior of the image forming apparatus 10 in Embodiment 1;

FIG. 6 shows a flowchart that explains consecutive counter control shown in FIG. 5;

FIG. 7 shows a flowchart that explains ejection control in Embodiment 1;

FIG. 8 shows a diagram that explains substitutional ejection in Embodiment 2;

FIG. 9 shows a flowchart that explains substitutional ejection in Embodiment 2; and

FIG. 10 shows a flowchart that explains position of substitutional ejections in Embodiment 4.

### DETAILED DESCRIPTION

Hereinafter, embodiments according to an aspect of the present disclosure will be explained with reference to drawings.

### Embodiment 1

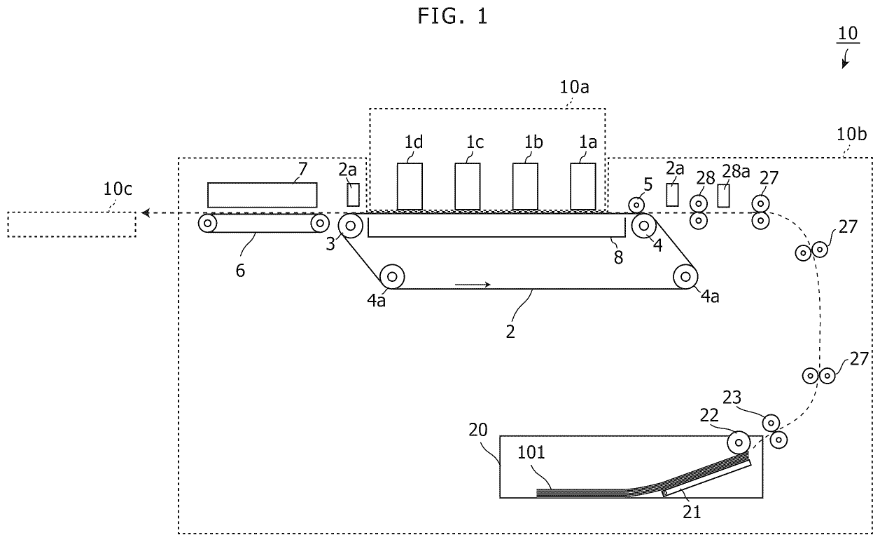

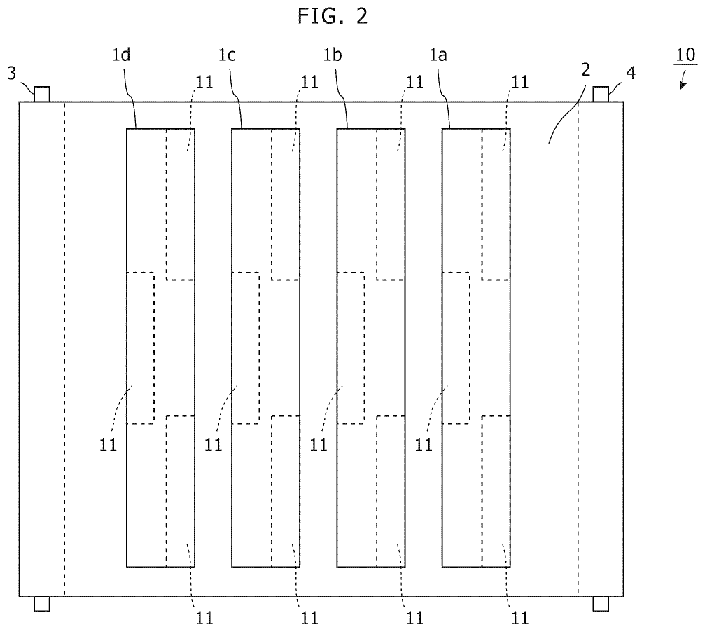

FIG. 1 shows a side view that indicates an internal mechanical configuration of an image forming apparatus in an embodiment according to the present disclosure. FIG. 2 shows a plane view of the image forming apparatus shown in FIG. 1. The image forming apparatus 10 in this embodiment is an apparatus such as printer, copier, facsimile machine or multi function peripheral, and includes an inkjet color printing mechanism of a line head type in this embodiment.

The image forming apparatus 10 shown in FIG. 1 includes a print engine 10a and a sheet transportation unit 10b. The print engine 10a physically prints an image to be printed on a print sheet (print paper sheet or the like). An ink cartridge is enabled to be mounted and demounted to and from the print engine 10a, and the print engine 10a performs printing using ink supplied from the ink cartridge. The sheet transportation unit 10b transports to the print engine 10a the print sheet.

In this embodiment, the print engine 10a includes line-head-type inkjet recording units 1a to 1d corresponding to four ink colors: Cyan, Magenta, Yellow, and Black, and ejects ink onto the print sheet using the recording units 1a to 1d.

As shown in FIG. 2, for example, in this embodiment, each of the recording heads 1a to 1d includes plural (here, three) head units 11. The head units 11 are arranged along a primary scanning direction, and are capable of being mounted to and demounted from a main body of the image forming apparatus. The head unit 11 (i.e. each recording head 1a, 1b, 1c or 1d) includes plural nozzles arranged in a primary scanning direction, and ejects ink from the nozzles to a print sheet.

Further, in this embodiment, the sheet transportation unit 10b includes (a) a circular-type transportation belt 2 that is arranged so as to be opposite to the print engine 10a and transports a print sheet, (b) a driving roller 3, a driven roller 4, a and tension roller 4a around which the transportation belt 2 is hitched, (c) a nipping roller 5 that nips the print sheet with the transportation belt 2, (d) a post-stage transportation belt 6, and (e) a dryer 7.

The driving roller 3, the driven roller 4, and the tension roller 4a cause the transportation belt 2 to rotate. The nipping roller 5 nips an incoming print sheet 101 transported from a sheet feeding cassette 20 mentioned below, and the nipped print sheet 101 is transported by the transportation belt 2 to printing positions of the inkjet recording units 1a to 1d in turn, and on the print sheet 101, images of respective colors are printed by the inkjet recording units 1a to 1d. In this situation, the passing print sheet is detected by a sheet sensor 2a, and a current position of the print sheet on a transportation path is determined on the basis of a detection timing by the sheet sensor 2a, and thereby an image is printed at a proper position on the print sheet. Subsequently, the print sheet after printing is outputted by the post-stage transportation belt 6 to an output tray 10c or the like. In this process, the print sheet on which the ink has been ejected is dried by the dryer 7.

Further, sheet suction units 8 are arranged along the transportation path of the print sheet. A negative pressure is applied to the sheet suction units 8, and thereby the print sheet is adsorbed to the transportation belt 2.

Further the sheet transportation unit 10b includes a sheet feeding cassette 20 as a sheet supply source. The sheet feeding cassette 20 stores print sheets 101, and pushes up the print sheets 101 using a lift plate 21 so as to cause the print sheets 101 to contact with a pickup roller 22. The print sheets 101 put on the sheet feeding cassette 20 are picked up to a sheet feeding roller 23 by the pickup roller 22 sheet by sheet from the upper side. The sheet feeding roller 23 is a roller that transports the print sheets 101 sheet by sheet fed by the pickup roller 22 from the sheet feeding cassette 20 onto a transportation path.

A transportation roller 27 is a roller to transport the print sheet 101 on a predetermined transportation path. A registration roller 28 temporarily stops the print sheet 101 when the incoming print sheet 101 in transportation is detected by a registration roller 28a, and transports this print sheet 101 to the print engine 10a (specifically, at a nipping position of the nipping roller 5 and the transportation belt 2) at a secondary sheet feeding timing. The secondary sheet feeding timing is instructed by a controller 75 mentioned below such that an image is formed at a specified position on the print sheet 101.

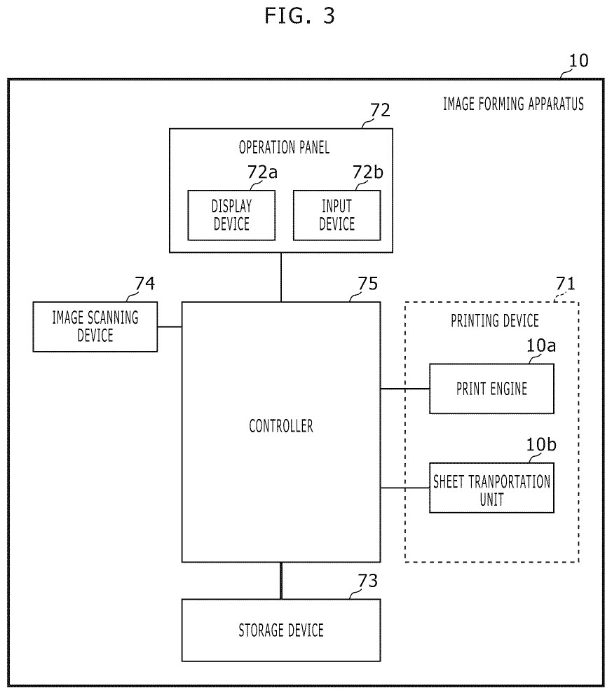

FIG. 3 shows a block diagram that indicates an electronic configuration of the image forming apparatus 10 in the embodiment according to the present disclosure. As shown in FIG. 3, the image forming apparatus 10 includes not only a printing device 71 that includes the mechanical configuration shown in FIGS. 1 and 2 but an operation panel 72, a storage device 73, an image scanning device 74, and a controller 75.

The operation panel 72 is arranged on a housing surface of the image forming apparatus 10, and includes a display device 72a such as a liquid crystal display and an input device 72b such as a hard key and/or a touch panel, and displays sorts of messages for a user using the display device 72a and receives a user operation using the input device 72b.

The storage device 73 is a non-volatile storage device (flash memory, hard disk drive or the like) in which data, a program and the like have been stored that are required for control of the image forming apparatus 10.

The image scanning device 74 includes a platen glass and an auto document feeder, and optically scans a document image from a document put on the platen glass or a document fed by the auto document feeder, and generates image data of the document image.

The controller 75 includes a computer that operates in accordance with a program, an ASIC (Application Specific Integrated Circuit) or an FPGA (Field Programmable Gate Array) that performs a predetermined operation, and the like; and acts as sorts of processing units. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC and/or the FPGA if required).

The controller 75 causes the recording heads 1a to 1d to eject ink and thereby performs printing of an image. Specifically, the controller 75 controls the printing device 71 (the print engine 10a, the sheet transportation unit 10b and the like), and thereby performs a print job requested by a user. Here, the controller 75 performs a predetermined image process for an image (image data) specified by a user, and controls the print engine 10a (head units 11) to cause it to eject ink, and thereby forms the image on a print sheet.

Further, if a nozzle corresponding to a target pixel in an image specified by a user performs ink ejection continuously in lines of a predetermined first line number, and both of two nozzles corresponding to both adjacent pixels to the target pixel do not perform ink ejection continuously in lines of a predetermined second line number, then the controller 75 causes the recording head 1a, 1b, 1c or 1d to perform ink ejection of both of the two nozzles instead of ink ejection of the nozzle corresponding to the target pixel.

As mentioned, when the target pixel is an ink ejection pixel, if the nozzles corresponding to the adjacent pixels are set as non ink ejection continuously as mentioned, then substitutional ink ejection is performed using the nozzles corresponding to the adjacent pixels. Consequently, nozzles that do not eject ink in a long term are reduced.

Specifically, the controller 75 (a) includes a first consecutive counter CNT_BLK[x] for consecutive line number of ink ejection and a second consecutive counter CNT_WHT[x] for consecutive line number of non ink ejection, for each pixel position x in a primary scanning direction, (b) determines whether the nozzle corresponding to the target pixel performs ink ejection continuously in lines of the predetermined first line number or not on the basis of a value of the first consecutive counter CNT_BLK[x], and (c) determines whether one or both nozzles corresponding to the two nozzles corresponding to the both adjacent pixels do not perform ink ejection continuously in lines of the predetermined second line number or not on the basis of values of the second consecutive counters CNT_WHT[x]. Specifically, if a value of the consecutive counter CNT_BLK[x] of a target pixel exceeds a threshold value TH1, then it is determined that a nozzle corresponding to the target pixel performs ink ejection continuously in lines of the predetermined first line number; and if one or both of values of the consecutive counter CNT_WHT[x] of the adjacent pixels exceed(s) a threshold value TH2, then it is determined that one or both of nozzles corresponding to the adjacent pixels does not/do not perform ink ejection continuously in lines of the predetermined second line number.

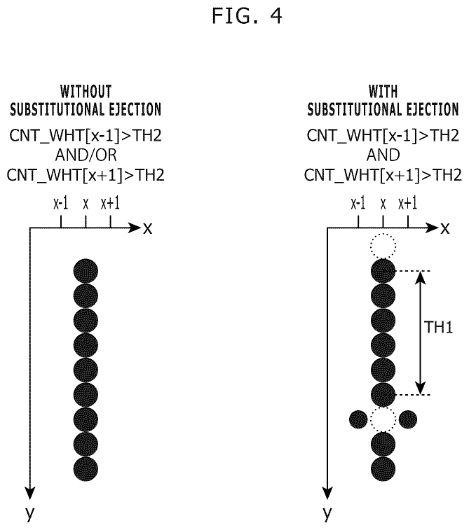

FIG. 4 shows a diagram that explains substitutional ejection in Embodiment 1. As shown in FIG. 4, for example, in Embodiment 1, when the controller 75 causes the recording head 1a, 1b, 1c or 1d to perform ink ejection of both of the two nozzles instead of ink ejection of the nozzle corresponding to the target pixel, the controller 75 decreases both of ink ejection amounts of the two nozzles to be smaller than an ink ejection amount of the nozzle corresponding to the target pixel.

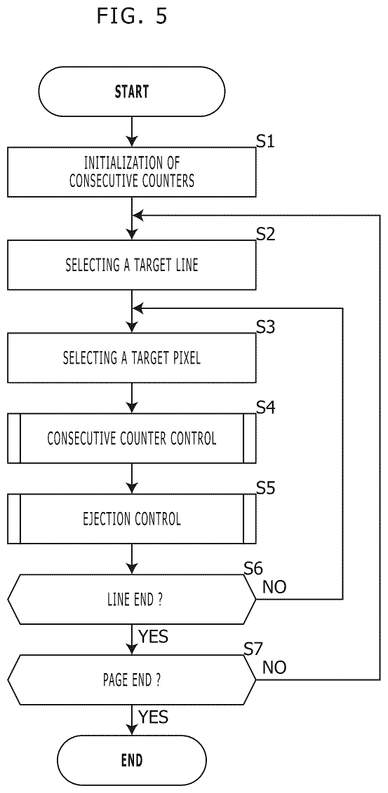

The following part explains a behavior of the image forming apparatus 10 in Embodiment 1. FIG. 5 shows a flowchart that shows a behavior of the image forming apparatus 10 in Embodiment 1.

When receiving a job request, the controller 75 performs the requested print job, and performs the following process for image data of an image to be printed, every page in the print job.

Firstly, the controller 75 initializes the consecutive counters CNT_BLK[x], CNT_WHT[x] of all pixel positions in a primary scanning direction to zero (in Step S1).

Subsequently, the controller 75 selects a target line (line position y) along a secondary scanning direction (in Step S2), and selects a target pixel (pixel position) along the primary scanning direction (in Step S3).

For the target pixel in the target line, the controller 75 performs consecutive counter control mentioned below (in Step S4), and performs ejection control mentioned below (in Step S5). In the ejection control, if required, the substitutional ejection is selected and the image data of the current page is changed correspondingly to the substitutional ejection.

Afterward, the controller 75 determines whether the current target pixel is a pixel at a line end or not (in Step S6), and if the current target pixel is not a pixel at a line end, then returning to Step S3, the controller 75 selects a next target pixel along the primary scanning direction (in Step S3), and performs the process in Step S4 and its subsequent processes as well.

Contrarily, if the current target pixel is a pixel at a line end, then the controller 75 terminates the process for the current target line, and determines whether the current line is a line at a page end or not (in Step S7). If the current line is not a line at a page end, then returning to Step S2, the controller 75 selects a next target line along the secondary scanning direction (in Step S2), and performs the process in Step S3 and its subsequent processes as well.

As mentioned, image data for which the ejection control has been performed every page is obtained, and the controller 75 causes the printing device 71 to print an image of each page based on the image data after the ejection control.

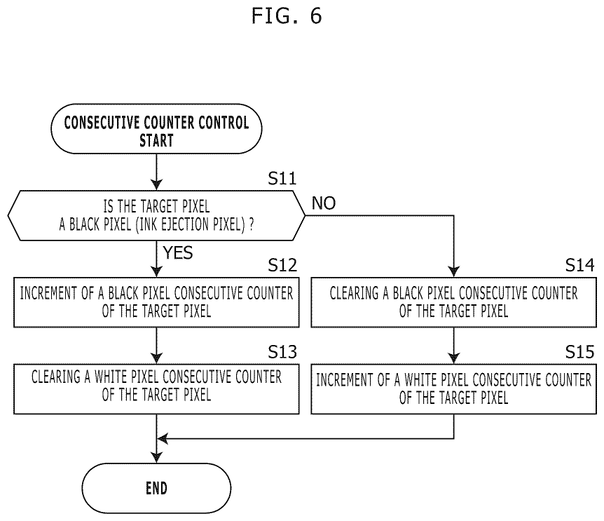

Here, the consecutive counter control is explained. FIG. 6 shows a flowchart that explains the consecutive counter control shown in FIG. 5.

In the consecutive counter control, the controller 75 firstly determines whether the target pixel (pixel position x) is a black pixel (i.e. ink ejection pixel) or not (in Step S11). Specifically, it is determined whether or not a value of the image data D[x] of the target pixel is a value that indicates ink ejection with a predetermined ink ejection amount.

If it is determined that the target pixel (pixel position x) is a black pixel, then the controller 75 performs increment (increasing by 1) of the black pixel consecutive counter CNT_BLK[x] of the target pixel (in Step S12), and clears the white pixel consecutive counter CNT_WHT[x] of the target pixel to a predetermined value (e.g. 0) (in Step S13).

Contrarily, if it is determined that the target pixel (pixel position x) is not a black pixel, then the controller 75 clears the black pixel consecutive counter CNT_BLK[x] of the target pixel to a predetermined value (e.g. 0) (in Step S14), and performs increment of the white pixel consecutive counter CNT_WHT[x] of the target pixel (in Step S15).

Therefore, if ink ejection continues along the secondary scanning direction at a pixel position x in the primary scanning direction, then a value of the black pixel consecutive counter CNT_BLK[x] increases; and if non ink ejection continues along the secondary scanning direction, then a value of the white pixel consecutive counter CNT_WHT[x] increases.

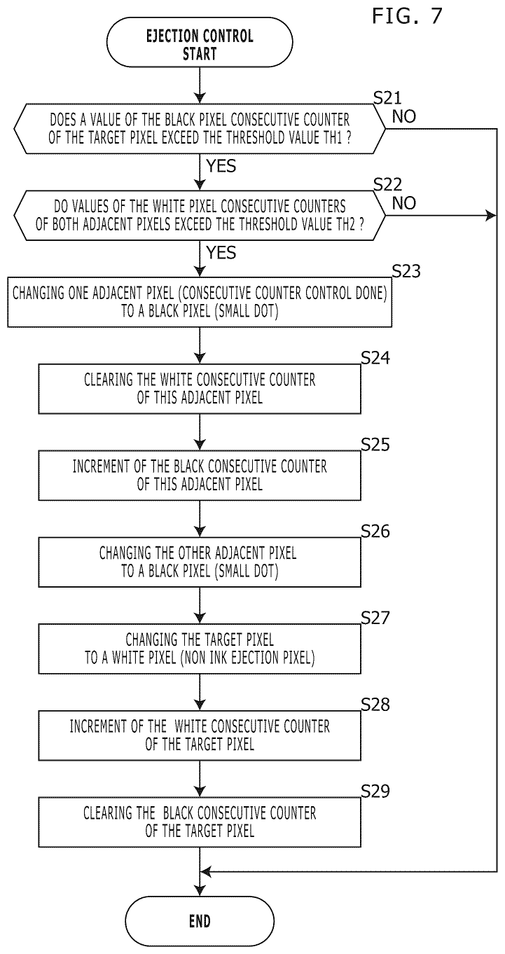

Here, the ejection control in Embodiment 1 is explained. FIG. 7 shows a flowchart that explains the ejection control in Embodiment 1.

In the ejection control, the controller 75 firstly determines whether a value of the black pixel consecutive counter CNT_BLK[x] of the target pixel (pixel position x) exceeds a threshold value TH1 or not (in Step S21).

If the value of the black pixel consecutive counter CNT_BLK[x] exceeds the threshold value TH1, then the controller 75 determines whether both values of the white pixel consecutive counters CNT_WHT[x+1], CNT_WHT[x−1] of the both adjacent pixels (pixel positions x+1, x−1) exceed a threshold value TH2 or not (in Step S22).

If the both values of the white pixel consecutive counters CNT_WHT[x+1], CNT_WHT[x−1] exceed the threshold value TH2, then the controller 75 firstly changes one of the adjacent pixels (pixel position x−1) from a white pixel (i.e. non ink ejection pixel) to a black pixel of a small dot (in Step S23). Specifically, a value of image data D[x−1] of the adjacent pixel is changed to a value corresponding to a black pixel of a small dot (i.e. a value corresponding to a dot size smaller than a dot size based on D[x]). Further, the controller 75 clears a value of the white pixel consecutive counter CNT_WHT[x−1] of this adjacent pixel to a predetermined value (in Step S24), and performs increment (increasing by 1) of the black pixel consecutive counter CNT_BLK[x−1] of this adjacent pixel (in Step S25).

Furthermore, the controller 75 changes the other of the adjacent pixels (pixel position x+1) from a white pixel to a black pixel of a small dot (in Step S26). Specifically, a value of image data D[x+1] of the adjacent pixel is changed to a value corresponding to a black pixel of the aforementioned small dot. It should be noted that renewal of values of the white pixel consecutive counter CNT_WHT[x+1] and black pixel consecutive counter CNT_BLK[x+1] is not performed here but will be performed in next consecutive counter control.

Subsequently, the controller 75 changes the target pixel from a black pixel to a white pixel (in Step S27). Specifically, a value of image data D[x] of the target pixel is changed to a value that indicates a white pixel. Further, the controller 75 performs increment of the white pixel consecutive counter CNT_WHT[x] of the target pixel (in Step S28), and clears a value of the black pixel consecutive counter CNT_BLK[x] of the target pixel to a predetermined value (in Step S29).

Meanwhile, if in Step S21 it is determined that a value of the black pixel consecutive counter CNT_BLK[x] does not exceed the threshold value TH1 or if in Step S22 it is determined that at least one of values of the white pixel consecutive counters CNT_WHT[x+1], CNT_WHT[x−1] does not exceed the threshold value TH2, then the controller 71 does not perform the change of the image data for the aforementioned substitutional ink ejection.

As mentioned, in Embodiment 1, the controller 75 causes the recording heads 1a to 1d to eject ink and thereby performs printing of an image. Further, if a nozzle corresponding to a target pixel in an image to be printed performs ink ejection continuously in lines of a predetermined first line number, and both of two nozzles corresponding to both adjacent pixels to the target pixel do not perform ink ejection continuously in lines of a predetermined second line number, then the controller 75 causes the recording head 1a, 1b, 1c or 1d to perform ink ejection of both of the two nozzles instead of ink ejection of the nozzle corresponding to the target pixel.

Consequently, such substitutional ink ejection in printing an image to be printed is performed, and thereby image quality degradation due to ink viscosity increase is restrained without preliminary ink ejection even when a line-head-type recording head is used for ink ejection. Therefore, the recording heads 1a to 1d do not perform preliminary ink ejection.

### Embodiment 2

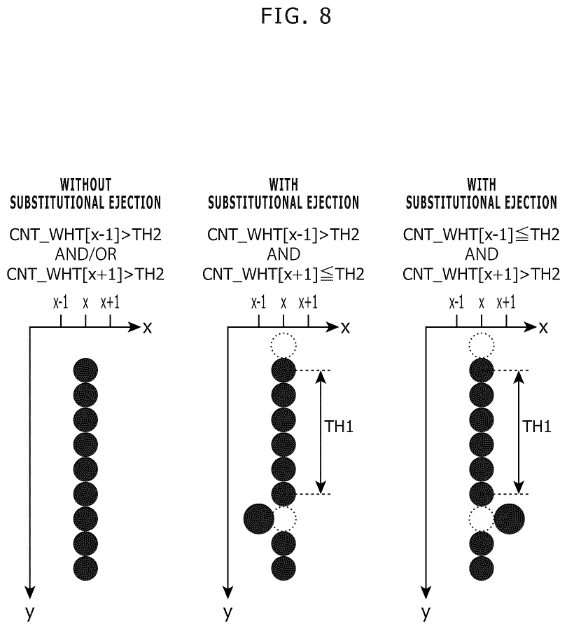

FIG. 8 shows a diagram that explains substitutional ejection in Embodiment 2.

As shown in FIG. 8, for example, if a nozzle corresponding to a target pixel in an image to be printed performs ink ejection continuously in lines of a predetermined first line number, and only one of two nozzles corresponding to both adjacent pixels to the target pixel does not perform ink ejection continuously in lines of a predetermined second line number, then the controller 75 causes the recording head 1a, 1b, 1c or 1d to perform ink ejection of the only one of the two nozzles instead of ink ejection of the nozzle corresponding to the target pixel. When the controller 75 causes the recording head 1a, 1b, 1c or 1d to perform ink ejection of only one of the two nozzles instead of ink ejection of the nozzle corresponding to the target pixel, the controller 75 increases an ink ejection amount of the one of the two nozzles to be larger than an ink ejection amount of the nozzle corresponding to the target pixel.

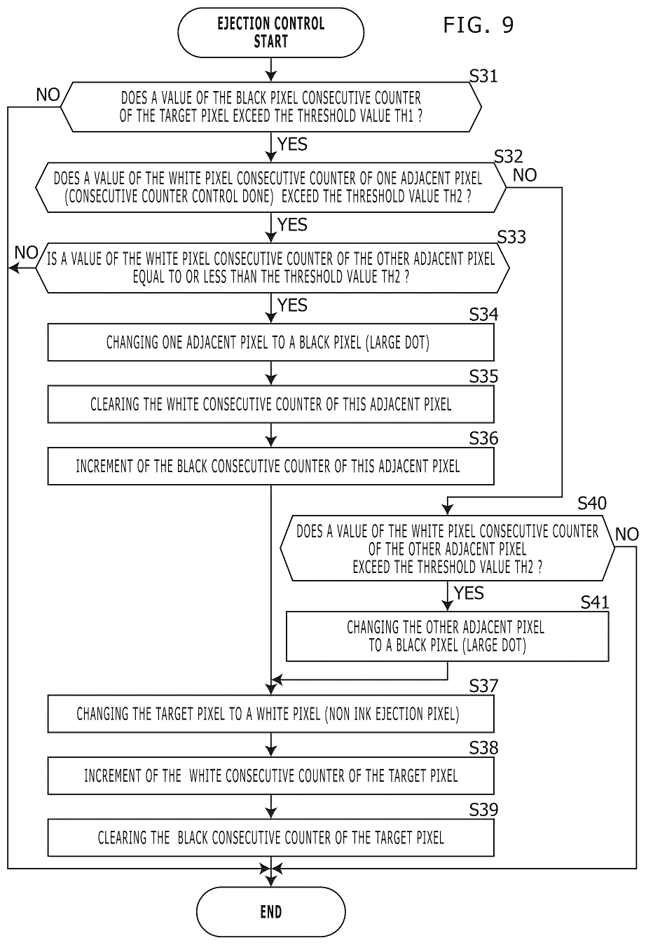

The following part explains a behavior of the image forming apparatus 10 in Embodiment 2. FIG. 9 shows a flowchart that explains substitutional ejection in Embodiment 2.

In the ejection control of Embodiment 2, the controller 75 firstly determines whether a value of the black pixel consecutive counter CNT_BLK[x] of the target pixel (pixel position x) exceeds a threshold value TH1 or not (in Step S31).

If the value of the black pixel consecutive counter CNT_BLK[x] exceeds the threshold value TH1, then the controller 75 determines whether a value of the white pixel consecutive counter CNT_WHT[x−1] of one of the adjacent pixels (at a pixel position x−1) exceeds a threshold value TH2 or not (in Step S32).

If the value of the white pixel consecutive counter CNT_WHT[x−1] exceeds the threshold value TH2, then the controller 75 determines whether a value of the white pixel consecutive counter CNT_WHT[x+1] of the other of the adjacent pixels (at a pixel position x+1) is equal to or less than the threshold value TH2 or not (in Step S33).

If the value of the white pixel consecutive counter CNT_WHT[x−1] of an adjacent pixel (pixel position x−1) exceeds the threshold value TH2 and the value of the white pixel consecutive counter CNT_WHT[x+1] of the other adjacent pixel (pixel position x+1) is equal to or less than the threshold value TH2, then the controller 75 changes the adjacent pixel (of which a value of the white pixel consecutive counter exceeds TH2) from a white pixel to a black pixel of a large dot (in Step S34). Specifically, a value of image data D[x−1] of the adjacent pixel is changed to a value corresponding to a black pixel of a large dot (i.e. a value corresponding to a dot size larger than a dot size based on D[x]). Further, the controller 75 clears a value of the white pixel consecutive counter CNT_WHT[x−1] of this adjacent pixel to a predetermined value (in Step S35), and performs increment of the black pixel consecutive counter CNT_BLK[x−1] of this adjacent pixel (in Step S36).

Further, the controller 75 changes the target pixel from a black pixel to a white pixel (in Step S37), performs increment of the white pixel consecutive counter CNT_WHT[x] of the target pixel (in Step S38), and clears a value of the black pixel consecutive counter CNT_BLK[x] of the target pixel to a predetermined value (in Step S39).

Contrarily, if in Step S32 it is determined that the value of the white pixel consecutive counter CNT_WHT[x−1] of the adjacent pixel does not exceed the threshold value TH2, then the controller 75 determines whether a value of the white pixel consecutive counter CNT_WHT[x+1] of the other adjacent pixel (pixel position x+1) exceeds the threshold value TH2 or not (in Step S40).

If the value of the white pixel consecutive counter CNT_WHT[x−1] of an adjacent pixel (pixel position x−1) does not exceed the threshold value TH2 and the value of the white pixel consecutive counter CNT_WHT[x+1] of the other adjacent pixel (pixel position x+1) exceeds the threshold value TH2, then the controller 75 changes the other adjacent pixel (of which a value of the white pixel consecutive counter exceeds TH2) from a white pixel to a black pixel of a large dot (in Step S41). Specifically, a value of image data D[x+1] of the other adjacent pixel is changed to a value corresponding to a black pixel of the aforementioned large dot. Afterward, a process of Step S37 and its subsequent processes are performed as well.

Meanwhile, if in Step S31 it is determined that a value of the black pixel consecutive counter CNT_BLK[x] does not exceed the threshold value TH1, if in Step S33 it is determined that a value of the white pixel consecutive counters CNT_WHT[x+1] is not equal to or less than the threshold value TH2, or if in Step S40 it is determined that a value of the white pixel consecutive counters CNT_WHT[x+1] does not exceed the threshold value TH2, then the controller 71 does not perform of the change of the image data for the aforementioned substitutional ink ejection.

Other parts of the configuration and behaviors of the image forming apparatus in Embodiment 2 are identical or similar to those in Embodiment 1, and therefore not explained here.

### Embodiment 3

In Embodiment 3, both of the ejection control of Embodiment 1 and the ejection control of Embodiment 2 are performed. Specifically, if nozzles corresponding to both adjacent pixels of a target pixel are set as non ink ejection continuously in lines of a predetermined line number, then the nozzles corresponding to the both adjacent pixels perform the substitutional ink ejection as mentioned in Embodiment 1; and if only one of nozzles corresponding to both adjacent pixels of a target pixel is set as non ink ejection continuously in lines of the predetermined line number, then the nozzle corresponding to the adjacent pixel (that is continuously set as non ink ejection in lines) performs the substitutional ink ejection as mentioned in Embodiment 2.

Other parts of the configuration and behaviors of the image forming apparatus in Embodiment 3 are identical or similar to those in Embodiment 1 or 2, and therefore not explained here.

### Embodiment 4

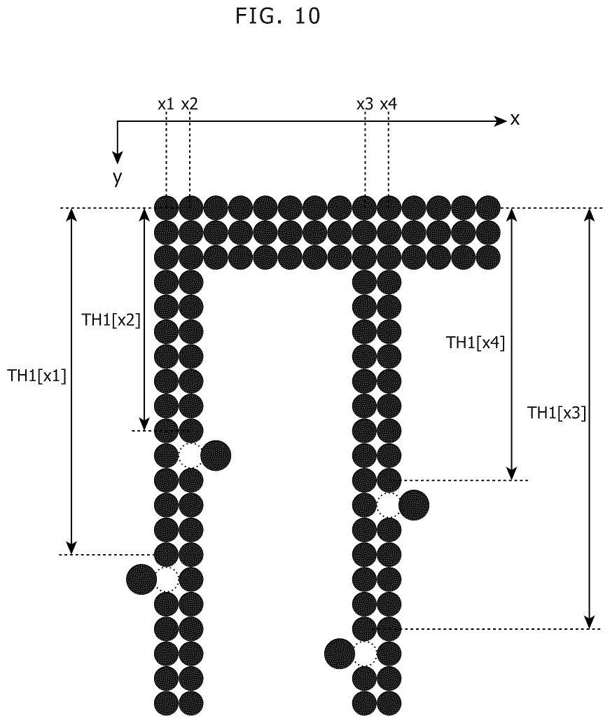

FIG. 10 shows a flowchart that explains positions of substitutional ejection in Embodiment 4. In Embodiment 4, as shown in FIG. 10, for example, the aforementioned predetermined first line numbers of pixel positions x of target pixels are individually set such that the first line number of a pixel position is different from the first line number of another pixel position. For example, in a case that an image to be printed includes a lattice pattern such as a table, if the aforementioned first line number is set to be constant, then substitutional ink ejection is performed at plural primary-scanning-directional positions on a certain line position and thereby an improper line may appear at the line position. However, if the aforementioned first line numbers are different from each other at pixel positions, then such improper line does not tend to appear.

Other parts of the configuration and behaviors of the image forming apparatus in Embodiment 4 are identical or similar to those in any of Embodiments 1 to 3, and therefore not explained here.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in Embodiments 1 to 4, a value of the black consecutive counter CNT_BLK[x] may be weighted correspondingly to an ink ejection amount (i.e. a value of the image data D[x]) of the ink ejection. In such a case, the larger the ink ejection amount is, the more the increment value is increased. If an ink ejection amount of the target pixel is large, then a dot size of the target pixel is large, and therefore the substitutional ink ejection is inconspicuously performed.

Further, in Embodiments 1 to 4, the initial value of the second consecutive counter CNT_WHT[x] after cleared may be set correspondingly to an ink ejection amount with which one or both of the aforementioned two nozzles eject(s) ink instead of ink ejection of a nozzle corresponding to the target pixel. In such a case, the smaller the ink ejection amount is, the larger the initial value after cleared is. In other words, the small ink ejection amount right before non ink ejection gains effect of ink viscosity increase, and therefore, the initial value after cleared is set to be large and consequently, the substitutional ink ejection tends to be performed in a short interval.

What is claimed is:

1. An image forming apparatus, comprising:
a line-head-type recording head that comprises plural nozzles, the recording head configured to eject ink through the nozzles; and
a controller configured to cause the recording head to eject ink and thereby perform printing of an image;
wherein if a nozzle corresponding to a target pixel in the image performs ink ejection continuously in lines of a predetermined first line number, and one or both of two nozzles corresponding to both adjacent pixels to the target pixel does not/do not perform ink ejection continuously in lines of a predetermined second line number, then the controller causes the recording head to perform ink ejection of one or both of the two nozzles instead of ink ejection of the nozzle corresponding to the target pixel.

2. The image forming apparatus according to claim 1, wherein the controller (a) decreases both of ink ejection amounts of the two nozzles to be smaller than an ink ejection amount of the nozzle corresponding to the target pixel when the controller causes the recording head to perform ink ejection of both of the two nozzles instead of ink ejection of the nozzle corresponding to the target pixel, and (b) increases an ink ejection amount of only one of the two nozzles to be larger than an ink ejection amount of the nozzle corresponding to the target pixel when the controller causes the recording head to perform ink ejection of the only one of the two nozzles instead of ink ejection of the nozzle.

3. The image forming apparatus according to claim 1, wherein the predetermined first line number is set individually for each pixel position of the target pixel, and the predetermined first line number of a pixel position of the target pixel is different from the predetermined first line number of another pixel position of the target pixel.

4. The image forming apparatus according to claim 1, wherein the controller (a) comprises a first consecutive counter for consecutive line number of ink ejection and a second consecutive counter for consecutive line number of non ink ejection, for each pixel position in a primary scanning direction, (b) determines whether the nozzle corresponding to the target pixel performs ink ejection continuously in lines of the predetermined first line number or not on the basis of a value of the first consecutive counter, and (c) determines whether one or both nozzles corresponding to the two nozzles corresponding to the both adjacent pixels does not/do not perform ink ejection continuously in lines of the predetermined second line number or not on the basis of values of the second consecutive counters;
the value of the first consecutive counter is weighted correspondingly to an ink ejection amount of the ink ejection; and
an initial value of the second consecutive counter for the target pixel after cleared is set correspondingly to an ink ejection amount with which the one or both of the two nozzles ejects/eject ink instead of ink ejection of the nozzle corresponding to the target pixel.

5. The image forming apparatus according to claim 1, wherein the recording head does not perform preliminary ink ejection.
